(19) United States
(12) Patent Application Publication
(10) Pub. No.: US 2026/0175246 A1
(43) Pub. Date: Jun. 25, 2026

(54) Pressure washer and method for operating a pressure washer

(71) Applicant: Andreas Stihl AG & Co. KG, Waiblingen (DE)

(72) Inventors: Simon Nadler, Stuttgart (DE); Stefan Baßmann, Backnang (DE); Rainer Grohmann, Ludwigsburg (DE); Richard Fresow, Remseck (DE)

(73) Assignee: Andreas Stihl AG & Co. KG, Waiblingen (DE)

(21) Appl. No.: 19/424,304

(22) Filed: Dec. 18, 2025

(30) Foreign Application Priority Data
Dec. 19, 2024 (DE) 102024138889.7

(51) Int. Cl. B05B 12/08; B05B 9/04; B05B 12/00

(52) U.S. Cl. CPC B05B 12/087; B05B 9/0403; B05B 12/002

(57) ABSTRACT

A pressure washer includes a main line for conveying liquid via a high-pressure pump, an operating device that generates a control signal dependent on actuation, and a pressure regulator that regulates pressure in the main line based on the control signal. In a standard mode, the pressure regulator regulates the pressure within a standard pressure range. During actuation of the operating device in standard mode, the pressure washer can be switched by an operating mode signal to a special mode. In the special mode, a set value is ascertained from one or more control signals and stored at least temporarily. The pressure regulator then regulates the pressure in the main line within a special pressure range that is restricted relative to the standard pressure range. The special pressure range is determined using the stored set value.

### CROSS-REFERENCE TO RELATED APPLICATION

This application claims the benefit of German Patent Application No. DE102024138889.7, filed 2024 Dec. 19, the content of which is incorporated in its entirety.

### TECHNICAL FIELD

The disclosure relates to a pressure washer.

### BACKGROUND

A pressure washer is known from EP 4 282 546 A1. The pressure in the main line of the pressure washer can be influenced by pivoting a pivot lever along a travel path. When the pivot lever is pivoted along the travel path to different actuation positions, the liquid is sprayed at different pressures. In some use cases, a certain pressure or pressure range has to be precisely maintained or selected. To do this, the user has to hold the pivot lever for a long time in a certain position. This is uncomfortable.

### SUMMARY

The present disclosure is based on the object of refining a generic pressure washer such that a certain pressure or pressure range can comfortably be precisely maintained or selected.

This object is solved by a pressure washer as disclosed and claimed.

A further object of the disclosure is to refine a generic method for operating a pressure washer such that a certain pressure or pressure range can comfortably be precisely maintained or selected.

This object is solved by a method as disclosed and claimed.

The pressure washer comprises a main line, through which liquid can be conveyed by means of a high-pressure pump. In particular, the pressure washer, in particular the main line, comprises a spray opening. In particular, the pressure washer, in particular the main line, comprises a port for a liquid source. In particular, liquid can be conveyed through the main line from the pump to the spray opening by means of the high-pressure pump.

The pressure washer comprises an operating device. The operating device generates a control signal that is dependent on an actuation of the operating device. In particular, the control signal depends on a degree of actuation of the operating device. In particular, the operating device can be adjusted along a travel path. In particular, the operating device can be adjusted along the travel path continuously. In particular, every position of the operating device, in particular of a pressure control element of the operating device, is linked to the generation of a certain, in particular different, pressure signal. The pressure washer comprises a pressure regulator. The pressure regulator regulates the pressure in the main line on the basis of the control signal generated by the operating device. This means that the pressure in the main line can be changed by means of the operating device. In particular, different control signals can be generated using the operating device.

During actuation of the operating device in standard mode, the pressure washer can be adjusted by means of an operating mode signal to a special mode. In the special mode, a set value is ascertained and saved at least temporarily. The set value is ascertained from one or more control signals. In special mode, the pressure in the main line can be regulated within a special pressure range by means of the pressure regulator. The special pressure range is restricted compared to the standard pressure range. In particular, the special pressure range lies fully within the standard pressure range. The special pressure range is determined using the set value.

Because the set value is based on one or more control signals, the set value is indirectly linked to the pressure in the main line that has been adjusted by the pressure regulator. Because the special pressure range is determined using the set value, the operator can use the information linked to the set value about the pressure in the main line for other functions of the pressure washer. This function lies in the fact that the special pressure range is determined using the set value. This special pressure range is restricted compared to the standard pressure range. However, the operator can also merely generate a certain control signal by means of the operating device and, without this control signal actually regulating the pressure in the main line within the standard pressure range in standard mode by means of the pressure regulator, determine the set value on the basis of this control signal and determine the special pressure range using the set value. Because the pressure values to which the pressure regulator can regulate the pressure in the main line are restricted to the special pressure range in special mode, a certain pressure or pressure range can comfortably be precisely maintained or selected.

In particular, the operating device comprises a pressure control element, which is used to generate the control signal.

In particular, in the pressure washer standard mode, the pressure regulator can regulate the pressure in the main line exclusively within the standard pressure range. In particular, the operating mode signal differs from the control signal. In particular, the operating mode signal can be generated by the operator in particular by means of actuation of the pressure washer.

In particular, in the pressure washer standard mode, liquid can be sprayed, in particular through the spray opening. However, it can also be provided that in standard mode, the operating device is operated without liquid being sprayed. The control signal generated by the operating device or the multiple control signals generated by the operating device can also be used in this case to ascertain a set value, which is then saved and used to determine the special pressure range.

In particular, in special mode, the control signal generated by the operating device, in particular by the pressure control element of the operating device, at the moment of switching to the special mode is saved at least temporarily as a set value. This happens in particular during the spraying of liquid. Therefore, if the operator generates a certain control signal by means of the operating device and the pressure regulator regulates the pressure in the main line on the basis of this control signal, the operator can switch to special mode by triggering the operating mode signal as soon as the pressure washer sprays the liquid with a pressure of interest for the operator. The moment of switching to the special mode is in particular determined by the moment at which the operating mode signal is generated. Because the control signal generated at this moment is saved at least temporarily as a set value, the user can use this set value to record, in particular save, information about the pressure in the main line. Using this information, they can trigger further functions of the pressure washer. In particular, the thus ascertained set value can be used to determine the special pressure range. It can also be provided that, in special mode, the control signal generated by the operating device at the moment of switching to the special mode is first multiplied by a factor and then saved at least temporarily as a set value. It can likewise be provided that an absolute value is added to the control signal generated at the moment of switching to special mode, or is subtracted therefrom, and the thus obtained value is saved as a set value.

It can also be provided that the set value is determined as a temporal mean of multiple control signals from a time interval. The time interval can be directly prior to the generation of the operating mode signal. In particular, the control signals are saved in standard mode as a function of time. In particular, the time interval is from 1 s to 20 s, in particular from 1 s to 10 s, in particular at most 10 s, in particular at most 5 s, in particular 10 s, in particular 5 s. It can also be provided that the time interval lies chronologically after the generation of the operating mode signal.

In an advantageous refinement, the special mode is a first special operating mode. In particular, the special pressure range in the first special operating mode is an individual pressure value. This individual pressure value is in particular the pressure value corresponding to the set value in standard mode. In particular, the pressure regulator regulates the pressure in the main line to the individual pressure value in the first special operating mode independently of the control signal. In other words, in the first special operating mode, the pressure is regulated in the main line by the pressure regulator exclusively based on the set value. The generation by means of the operating device of control signals that deviate from the set value is disregarded in the first special operating mode. To regulate the pressure in the main line, the control signals generated by the operating device that deviate from the set value are irrelevant. The first special operating mode can in particular also be referred to as fixed pressure mode. In particular, it can be provided that the operating device is fixed in the first special operating mode in a fixed position with a fixed degree of actuation. In particular, in the first special operating mode, it is not possible to change the degree of actuation of the operating device. However, it can also be provided that given different degrees of actuation of the operating device in the first special operating mode, it is only ever the set value that serves as a basis for providing the pressure in the main line by means of the pressure regulator. The first special operating mode can be used to select a certain pressure in the main line, in particular a certain pressure at which the liquid is sprayed. If the operator operates the operating device and would then like to continue operating it with the pressure currently prevailing in the main line, or with a pressure value based on this current pressure, they can do this by switching to the first special operating mode by means of a first operating mode signal. In particular, the control signal generated at the moment of switching to the first special operating mode is then multiplied by a factor, in particular by the factor 1, and saved at least temporarily as a set value. In particular, in the first special operating mode, the pressure regulator regulates the pressure in the main line on the basis of this set value. In particular, the pressure regulator regulates the pressure in the main line to a pressure value which corresponds to the pressure value which is regulated by the pressure regulator in standard mode during generation of a control signal that corresponds to the set value, in particular is the set value. The operator then does not have to always maintain a certain degree of actuation of the operating device, which is onerous; instead, the pressure washer is reliably operated at the same pressure in the first special operating mode. In particular, this can be the case even if the operating device is not operated at all, in particular for generating a control signal as a basis for the pressure regulation by means of the pressure regulator. In particular, the pressure in the main line is regulated by the pressure regulator independently of the actuation of the operating device. This makes comfortable operation of the pressure washer possible.

In a particular refinement, it is provided that the special mode is a second special operating mode. In particular, in the second special operating mode, at least one extreme value of the special pressure range is determined on the basis of the set value. In particular, the special pressure range, within which the pressure can be regulated in the main line by means of the pressure regulator, is delimited by a pressure value ascertained on the basis of the set value. In particular, this may be the upper limit and/or the lower limit of the special pressure range in the second special operating mode. In particular, in the second special operating mode, the pressure value assigned to the set value in standard mode is determined as the largest or the smallest pressure value of the special pressure range.

If the largest pressure value of the special pressure range in the second special operating mode corresponds to the pressure value assigned to the set value in standard mode, this pressure value assigned to the set value in standard mode is the upper limit of the special pressure range. Then, in the second special operating mode, irrespective of the degree of actuation of the operating device, it is only possible to regulate the pressure in the main line by means of the pressure regulator up to this largest pressure value, which corresponds to the pressure value assigned to the set value in standard mode.

If, in the second special operating mode, the pressure value assigned to the set value in standard mode is the smallest pressure value of the special pressure range, the pressure value assigned to the set value in standard mode is the lower limit of the special pressure range. Then, only operation above this smallest pressure value is possible. This is in particular the case irrespective of the degree of actuation of the operating device.

Furthermore, it can be provided that the degree of actuation of the operating device in the second special operating mode is limited by the position of the operating device, in particular of the pressure control element, which the operating device assumes, in particular which the pressure control device assumes, in standard mode when a control signal corresponding to the set value is generated. In particular, it can be provided that, in the second special operating mode, the operating device can be actuated exclusively between an initial position, in particular a rest position, and a position that corresponds to the position at which a control signal corresponding to the set value is generated in standard mode.

Alternatively, it can be provided that, in the second special operating mode, the operating device, in particular the pressure control element, can be actuated exclusively between the position at which a control signal corresponding to the set value is generated in standard mode and an end position, in particular an end location. In particular, the initial position, in particular the rest position, corresponds to the position of the operating device, in particular of the pressure control element, which the operating device assumes, in particular which the pressure control element assumes, in the non-actuated state in standard mode. In particular, the end position, in particular the end location, of the operating device, in particular of the pressure control element, corresponds to the position which the operating device assumes, in particular which the pressure control element assumes, in the fully actuated state in standard mode.

It can also be provided that both extreme values of the special pressure range are determined on the basis of the set value. A lower special limit pressure value of the special pressure range can correspond, for example, to a certain lower percentage value of the pressure assigned to the set value in standard mode. An upper special limit pressure value of the special pressure range can correspond, for example, to a certain upper percentage value of the pressure assigned to the set value in standard mode. The upper percentage value is greater than the lower percentage value. In particular, the upper percentage value is more than 100% and the lower percentage value is less than 100%. In particular, the mean of the lower percentage value and upper percentage value is from 90% to 110%, in particular 100%.

In particular, the lower special limit pressure value and the upper special limit pressure value delimit the special pressure range in the second special operating mode. It is then only possible to operate within these pressure limits. This is the case in particular irrespective of the degree of actuation of the operating device.

In a particular refinement, the special mode is a third special operating mode. In particular, the operating device, in particular the pressure control element of the operating device, can be adjusted along a travel path between two extreme positions. The extreme positions correspond to in particular the extreme positions of the operating device, in particular of the pressure control element, in standard mode. The extreme positions are in particular the extrema of the maximum possible travel path of the operating device, in particular of the pressure control element. In particular, an extreme position is the initial position, in particular the rest position. In particular, an extreme position is the end position, in particular the end location. In particular, the degree of actuation of the operating device corresponds to a position of the operating device, in particular of the pressure control element, along the travel path. In particular, the extreme positions are linked in standard mode with the extreme values of the standard pressure range. In particular, in the third special operating mode, the extreme positions are linked with the extreme values of the special pressure range. As a result, the smaller special pressure range is spread across the entire travel path, which was assigned to the larger standard pressure range in standard mode. Re-scaling takes place, as it were. This means that a finer selection of pressure values from the special pressure range is possible. As a result, a precise selection of a pressure value can be made conveniently in in the third special operating mode.

In particular, the entire spectrum of the control signals is spread across the smaller special pressure range. In particular, the assignment between the control signals generated by the operating device, in particular by the pressure control element, and the pressure values is different compared to in the standard mode. In particular, the pressure values of the special pressure range are spread uniformly across the maximum possible travel path of the operating device, in particular of the pressure control element.

In particular, it can be provided that, in the third special operating mode, at least one extreme value of the special pressure range is determined on the basis of the set value. In particular, in the third special operating mode, the pressure value assigned to the set value in standard mode is determined as the largest or the smallest pressure value of the special pressure range. This particular configuration of the third special operating mode represents, as it were, a combination of the third special operating mode with the second special operating mode. In this configuration of the third special operating mode, the upper or the lower end of the special pressure range is delimited by the pressure value assigned to the set value in standard mode and, at the same time, the special pressure range is spread across the maximum possible travel path of the operating device, in particular of the control element.

In this configuration of the third special operating mode as well, it can be provided that both extreme values of the special pressure range are determined on the basis of the set value. A lower special limit pressure value of the special pressure range can correspond, for example, to a certain lower percentage value of the pressure assigned to the set value in standard mode. An upper special limit pressure value of the special pressure range can correspond, for example, to a certain upper percentage value of the pressure assigned to the set value in standard mode. The upper percentage value is greater than the lower percentage value. In particular, the upper percentage value is more than 100% and the lower percentage value is more than 100%. In particular, the mean of the lower percentage value and upper percentage value is from 90% to 110%, in particular 100%.

In particular, the operating mode signal is a first mode signal for adjusting the pressure washer to the first special operating mode or a second mode signal for adjusting the pressure washer to the second special operating mode or a third mode signal for adjusting the pressure washer to the third special operating mode. In particular, every mode signal can be generated by the operator in a different way. As a result, the different special operating modes can be triggered easily.

In a particular refinement, the pressure washer has a button. In particular, the operating mode signal can be generated by actuating the button. In particular, the operating mode of the pressure washer can be adjusted back to standard mode by actuating the button in special mode. In standard mode, the pressure of the main lines can be regulated by means of the pressure regulator within the standard pressure range, which is unrestricted compared to the special pressure range. In particular, it is possible to switch back and forth between the standard mode and the special mode by means of the button.

In particular, the pressure washer has a first button, the actuation of which can generate the first mode signal, which can be used to switch to the first special operating mode. In particular, the pressure washer has a second button, the actuation of which can generate the second mode signal, which can be used to switch to the second special operating mode. In particular, the pressure washer has a third button, the actuation of which can generate the third mode signal, which can be used to switch to the third special operating mode. By actuating the respective button, it is possible to switch back from the respective special operating mode to standard mode again. In particular, it is possible to switch back and forth between the respective special operating mode and the standard mode by means of the respective button. It can also be provided that there is just one single button for all of the special operating modes combined. The individual special operating modes are alternated between, depending on how often this button is actuated.

In a particular refinement, it is provided that when the pressure washer is switched on, the pressure washer is always first set in standard mode. If the pressure washer is operated again after a relatively long time, or by another user, the user will always find the pressure washer to be in the same reliable state. However, it can be provided for the set values to be saved for a longer period of time. On renewed start-up of the pressure washer, one of the special operating modes can then be used on the basis of a previously saved set value. This makes it possible to operate the pressure washer with the previously preferred operating values even after a relatively long period of inactivity.

In particular, the main line has a suction chamber between the port and the high-pressure pump. In particular, the main line has a pressure chamber between the high-pressure pump and the spray opening. In particular, the pressure chamber is fluidically connected to the suction chamber via a bypass line. In particular, a bypass valve is arranged in the bypass line. In particular, an open cross-sectional area of the bypass line can be set by means of the bypass valve in order to regulate the pressure in the pressure chamber. In particular, the bypass valve can be adjusted by means of the operating device, in particular the pressure control element, in order to set the open cross-sectional area of the bypass line.

In particular, the pressure regulator comprises the bypass line and the bypass valve. In particular, the pressure regulator comprises a device for setting the open cross-sectional area of the bypass line, in particular for adjusting the bypass valve. In particular, the device for setting the open cross-sectional area of the bypass line, in particular for adjusting the bypass valve, is a servomotor. In particular, the pressure regulator comprises the servomotor.

In an alternative embodiment of the pressure washer, the design of the pressure regulator is not based on the bypass line. In particular, no bypass line is provided at all. Instead, the pressure in the main line, in particular in the pressure chamber, can be regulated within the standard pressure range by setting the output of the high-pressure pump. In particular, a motor is provided for this purpose to drive the high-pressure pump. In particular, in this alternative embodiment, the pressure regulator comprises the high-pressure pump and the motor to drive the high-pressure pump.

In the method for operating a pressure washer, the pressure washer comprises a main line through which liquid can be conveyed by means of the high-pressure pump, an operating device which generates a control signal that is dependent on an actuation, in particular on a degree of actuation, of the operating device, and a pressure regulator which regulates the pressure in the main line on the basis of the control signal. In a standard mode of the pressure washer, the pressure in the main line can be regulated within a standard pressure range by means of the pressure regulator. During the actuation of the operating device in standard mode, the pressure washer is adjusted by means of an operating mode signal to a special mode. In the special mode, a set value is ascertained from a control signal generated by the operating device, in particular at the moment of switching to the special mode, or from multiple control signals generated by the operating device, and the set value is saved temporarily. In particular, the set value is ascertained from the temporal mean of the multiple control signals. This may be the temporal mean in the time interval directly prior to the moment of switching to the special mode. In particular, the time interval is from 1 s to 20 s, in particular from 1 s to 10 s, in particular at most 10 s, in particular at most 5 s, in particular 10 s, in particular 5 s. It can also be provided that the time interval lies chronologically after the operating mode signal has been generated. In special mode, the pressure in the main line can be regulated within a special pressure range by means of the pressure regulator. The special pressure range is restricted compared to the standard pressure range. According to the method, the special pressure range is determined using the set value.

The method has the advantages mentioned above for the pressure washer that forms the subject matter. The method can be refined analogously to the pressure washer and is associated with the same advantages.

Exemplary embodiments of the invention are explained hereinafter with reference to the drawings.

### BRIEF DESCRIPTION OF THE DRAWINGS

FIG. 1 shows a perspective illustration of a pump unit of a pressure washer,

FIG. 2 and FIG. 3 show perspective illustrations of a handheld spray unit of the pressure washer,

FIG. 4 shows a side view of the handheld spray unit according to FIGS. 2 and 3,

FIG. 5 shows a schematic illustration of a pressure washer with non-actuated operating device, in particular with non-actuated pressure control element and non-actuated valve control element, wherein the pressure washer comprises a pressure regulator in the form of a bypass line with bypass valve and servomotor for the bypass valve,

FIG. 6 shows a schematic illustration of the pressure washer from FIG. 5 with partly actuated operating device, namely with actuated valve control element and non-actuated pressure control element,

FIG. 7 shows a schematic illustration of the pressure washer from FIG. 5 with fully actuated operating device, namely with actuated valve control element and actuated pressure control element,

FIG. 8 shows a schematic illustration of an alternative exemplary embodiment of a pressure washer with fully actuated operating device, namely with actuated valve control element and actuated pressure control element, wherein the pressure washer comprises a pressure regulator in the form of a high-pressure pump and a motor for driving same,

FIG. 9 shows a sectional view through the handheld spray unit from FIGS. 2 to 4 with non-actuated operating device, namely with non-actuated pressure control element and non-actuated valve element,

FIG. 10 shows a sectional view analogous to FIG. 9 with partly actuated operating device, namely with actuated valve control element and non-actuated pressure control element,

FIG. 11 shows a sectional view analogous to the sectional view from FIG. 9 with fully actuated operating device, namely with actuated valve control element and actuated pressure control element,

FIG. 12 shows an illustration of a detail from FIG. 9, and

FIG. 13 shows an illustration of a detail from FIG. 11.

### DETAILED DESCRIPTION

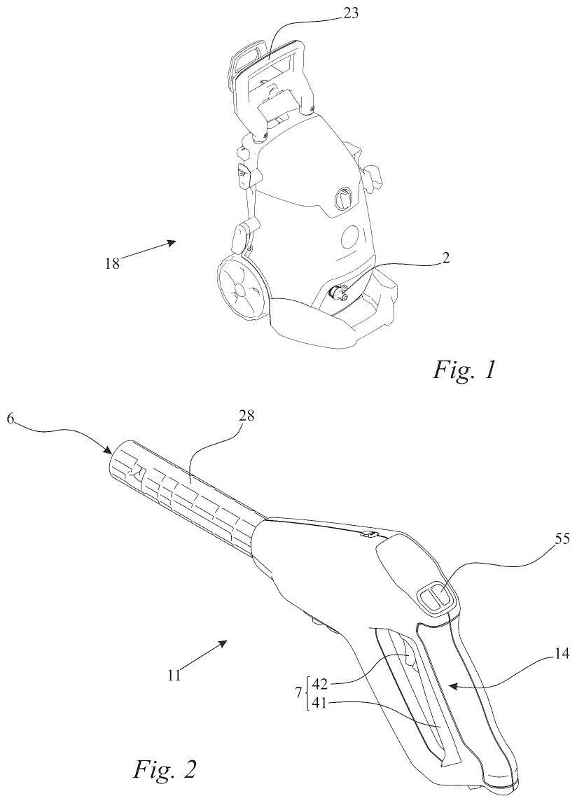

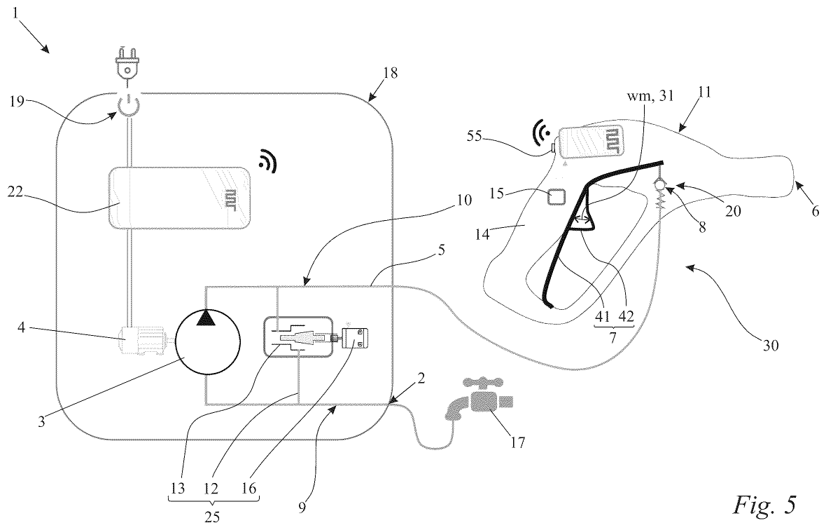

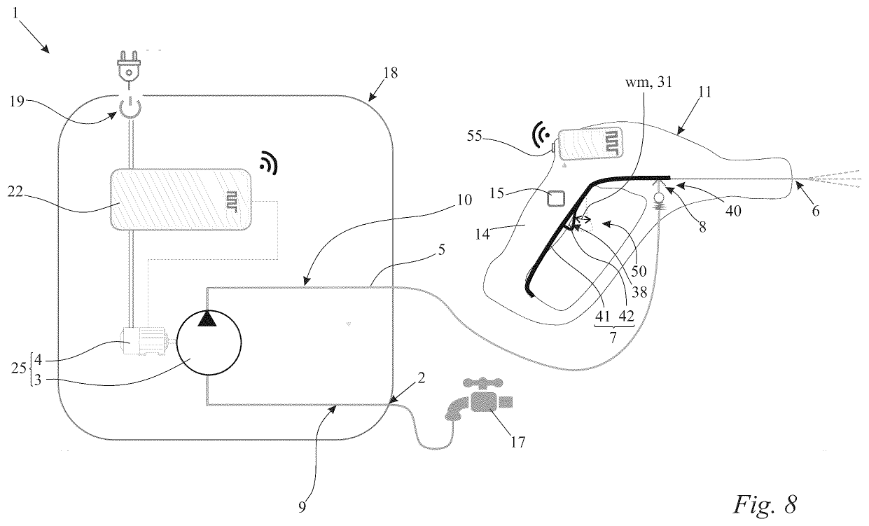

FIG. 1 shows a pump unit 18 of a pressure washer 1 shown schematically in FIG. 5. The pump unit 18 can also be designed according to the alternative exemplary embodiment according to FIG. 8.

In both embodiments of the pressure washer 1, the pressure washer 1 comprises a spray unit 11. The spray unit 11 can be designed as a spray gun, as shown schematically in FIG. 5 or FIG. 8. A spray opening 6 is arranged on the spray gun. Alternatively, the spray unit 11 can be designed as a spray gun with a lance 28, as shown in FIGS. 2 to 4. In this case, the spray opening 6 is arranged on the lance 28.

In all embodiments, the pressure in a main line 5 can be changed, in particular regulated, by means of a pressure regulator 25. The embodiments according to FIGS. 5 and 8 differ in terms of the configuration of the pressure regulator 25.

In total, therefore, four different embodiments are shown in the drawing. The following description relates, unless expressly mentioned otherwise, to all exemplary embodiments—even if the corresponding features have only been described in conjunction with one of the figures.

The pressure washer 1, in particular the spray unit 11, is designed for cleaning objects with pressurized cleaning liquid. In the exemplary embodiments, the pressure washer 1 is portable. The pressure washer 1 has a handle 23 shown in FIG. 1. The pressure washer 1, in particular the pump unit 18 of the pressure washer 1, can be carried by the handle 23. During normal operation, it is provided that the pressure washer 1, in particular the pump unit 18, is set down on the ground.

As shown in FIG. 5 or 8, the pressure washer 1 has a high-pressure pump 3. The high-pressure pump 3 is a component part of the pump unit 18. By means of the high-pressure pump 3, cleaning liquid in the pressure washer 1, in particular in the pump unit 18, can be pressurized. By means of the high-pressure pump 3, the cleaning liquid can be pressurized to a pressure of at least 10 bar, in particular of at least 15 bar, in particular of at least 30 bar, in particular of at least 100 bar. In particular, the cleaning liquid can be pressurized to a pressure of at most 600 bar, in particular of at most 500 bar using the high-pressure pump 3. The high-pressure pump 3 comprises at least one piston (not shown). The at least one piston can move back and forth in order to generate pressure on the cleaning liquid. The high-pressure pump 3 typically comprises three pistons.

As shown in FIGS. 1 and 5 or 8, the pressure washer 1, in particular the pump unit 18, comprises a port 2 for a liquid source 17. In the exemplary embodiments, the liquid source 17 is an external liquid source. In the exemplary embodiments, the external liquid source is the tap of a domestic water network. It can also be provided that the liquid source is an integral component part of the pressure washer 1. The pressure washer 1, in particular the handheld spray unit 11, comprises a spray opening 6.

As shown in FIG. 5 or 8, the pump unit 18 and the spray unit 11 are fluidically connected to one another via a main line 5 in all embodiments. The pressure washer 1 comprises the main line 5. The main line 5 fluidically connects the port 2 to the spray opening 6. The port 2 is arranged on the pump unit 18. The spray opening 6 is arranged on the spray unit 11. In the exemplary embodiment according to FIGS. 2 to 4, the spray opening 6 is arranged on a lance 28 of the spray unit 11. In the exemplary embodiment according to FIG. 5, the spray opening 6 is arranged on the spray unit 11 which is designed as a spray gun.

By means of the high-pressure pump 3, liquid can be conveyed through the main line 5 from the port 2 to the spray opening 6. The liquid source 17 supplies liquid to the main line 5. The high-pressure pump 3 is arranged in the main line 5. The high-pressure pump 3 pressurizes the liquid. The high-pressure pump 3 is arranged between a suction chamber 9 and a pressure chamber 10 of the main line 5. This is shown in FIG. 5. The main line 5 has the suction chamber 9 between the port 2 and the high-pressure pump 3. The main line 5 has the pressure chamber 10 between the high-pressure pump 3 and the spray opening 6. In the exemplary embodiments, the suction chamber 9 is formed by a section of the main line 5 between the port 2 and the high-pressure pump 3. In the exemplary embodiments, the pressure chamber 10 is formed by a section of the main line 5 between the high-pressure pump 3 and the spray opening 6. This section of the main line 5 extends in particular exactly from the high-pressure pump 3 exactly to the spray opening 6. The high-pressure pump 3 conveys liquid from the suction chamber 9 to the pressure chamber 10. A greater pressure prevails in the pressure chamber 10 than in the suction chamber 9. The suction chamber 9 and the pressure chamber 10 are component parts of the main line 5. A greater pressure prevails in the main line 5 downstream of the high-pressure pump 3 than upstream of the high-pressure pump 3.

The high-pressure pump 3 is arranged in the pump unit 18, in particular in a housing of the pump unit 18. The high-pressure pump 3 is separate from the spray unit 11. Different spray units 11 can be connected up to the high-pressure pump 3. To drive the high-pressure pump 3, the pressure washer 1 has a motor 4. The motor 4 is arranged in the pump unit 18. The motor 4 can be a brushless DC motor. A brushless DC motor is also referred to as an EC motor. The motor can also be a universal motor. In the exemplary embodiments, the motor 4 is an induction motor. In an induction motor, a revolving magnetic field of the stator sets the rotor in motion. The induction motor in the exemplary embodiments is operated with AC voltage. The voltage source can be supplied by the mains voltage, for example. If battery or rechargeable battery operation is provided, the motor can also be a brushless DC motor. It can then be provided that the rechargeable battery is a component part of the pressure washer 1. In particular, it can then be provided that the pump unit 18 is a component part of the handheld spray unit 11. In this case, the entire pressure washer 1 is portable when in operation and can be held with a hand. In particular, the pump unit and the spray unit are then integrally designed. In particular, the pump unit and the spray unit are then arranged in a shared housing. In particular, the pump unit and the spray unit are connected to one another rigidly, in particular not via a flexible hose.

As shown in FIG. 5 or 8, the pressure washer 1 comprises a main switch 19. The main switch 19 is used to interrupt the voltage supply to the entire pressure washer 1. The main switch 19 is arranged on the pump unit 18.

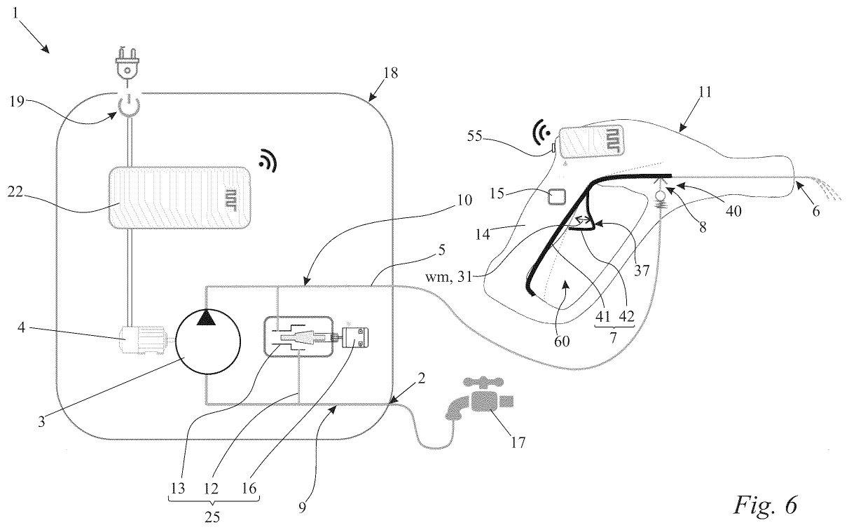

The pressure washer 1 comprises a main line valve 8. The main line valve 8 is arranged in the main line 5. In the exemplary embodiments, the main line valve 8 is arranged in the spray unit 11. The main line valve 8 has two valve states. The two valve states comprise a closed state 20 and a fully open state 40, as illustrated by way of example in FIGS. 5 and 6 and also for the exemplary embodiment according to FIG. 8. In the fully open state 40, the main line valve 8 allows liquid to flow through the main line 5. In the fully open state 40, the flow cross-section of the main line 5 at the position of the main line valve 8 is at its maximum. Opening the main line valve 8 further does not lead in the fully open state 40 to a larger flow cross-section for the liquid in the main line 5 at the position of the main line valve 8. In the closed state 20, the main line valve 8 prevents liquid from flowing through the main line 5, in particular fully. In the fully open state 40 of the main line valve 8, liquid is sprayed out of the spray opening 6 during operation of the pressure washer 1. In the closed state 20 of the main line valve 8, no liquid is sprayed out of the spray opening 6. In the exemplary embodiments, the main line valve 8 is arranged between the high-pressure pump 3 and the spray opening 6. However, it can also be provided that the main line valve 8 is arranged in the pump unit 18. It can also be provided that the main line valve 8 is arranged between the port 17 and the high-pressure pump 3.

The pressure washer 1 comprises a pressure regulator 25 shown in FIGS. 5 to 7 or in an alternative embodiment in FIG. 8. By means of the pressure regulator 25, the pressure in the main line 5, in particular in the pressure chamber 10, can be changed, in particular it can be regulated.

The pressure washer 1, in particular the spray unit 11, has an operating device 7. The operating device 7 is separate from the main switch 19. The pressure regulator 25 can be operated by means of the operating device 7.

In particular, the main line valve 8 can be switched by means of the operating device 7 between the fully open state 20 and the closed state 40. In the exemplary embodiments, the operating device 7 is arranged on the spray unit 11.

The operating device 7 generates a control signal that is dependent on an actuation, in particular a degree of actuation of the operating device 7. On the basis of the control signal, the pressure regulator 25 regulates the pressure in the main line 5, in particular in the pressure chamber 10.

In the exemplary embodiments, the operating device 7 has a valve control element 41 and a pressure control element 42. The valve control element 41 is used to actuate the main line valve 8, in particular to switch between the closed state 20 and the fully open state 40. The pressure control element 42 is used to actuate the pressure regulator 25. Alternatively to the exemplary embodiments, it can also be provided that the operating device 7 consists of a single control element which serves to actuate both the main line valve 8 and the pressure regulator 25. By way of example, it can be provided that the single control element can be adjusted along a travel path. On initial actuation of the single control element, firstly the main line valve 8 is opened and, after part of the travel path has been covered, then the pressure regulator 25 is actuated and the pressure in the main line 5, in particular in the pressure chamber 10, is changed, in particular regulated. Depending on the degree of actuation, i.e. depending on how much of the travel path has been covered, the pressure regulator 25 then regulates the pressure in the main line 5, in particular in the pressure chamber 10. In particular, the single control element generates a control signal that is dependent on the degree of actuation of the control element, on the basis of which the pressure regulator 25 regulates the pressure in the main line 5, in particular in the pressure chamber 10.

In the exemplary embodiments, the operating device 7 comprises the pressure control element 42 and the valve control element 41. The pressure control element 42 can be operated independently of the valve control element 41. The pressure washer 1, in particular the spray unit 11, is designed such that the valve control element 41 can be actuated without actuation of the pressure control element 42. It can be provided that the pressure washer 1, in particular the spray unit 11, is designed such that the pressure control element 42 can be actuated without the valve control element 41 simultaneously being actuated. However, such a coupling can also be envisaged. In particular, it can be provided that the pressure control element 42 can be pressed mechanically without the valve control element 41 being simultaneously pressed in the process. In the exemplary embodiments, the pressure washer 1 is designed such that the pressure control element 42 does not trigger a function if it is actuated without simultaneous actuation of the valve control element 41. In this case, at least no change in the pressure in the main line is triggered by the pressure control element 42, in particular not by the pressure regulator 25. This separation of mechanical actuation and functional release is achieved by means of control technology.

The main line valve 8 can be switched by means of the valve control element 41 between the fully open state 40 and the closed state 20. The pressure of the liquid in the main line 5 in the section between the high-pressure pump 3 and the spray opening 6 can be changed, in particular specified, by means of the pressure control element 42. The pressure of the liquid in the pressure chamber 10 can be changed, in particular specified, by means of the pressure control element 42. In particular, the pressure of the liquid in the main line 5 in the section between the high-pressure pump 3 and the spray opening 6 can be changed, in particular specified, by means of the pressure control elements 42 in the fully open state 40 of the main line valve 8. It can be provided that the pressure of the liquid in the main line 5 in the section between the high-pressure pump 3 and the spray opening 6 can be changed, in particular regulated, by means of the pressure control element 42.

A first exemplary embodiment for the pressure regulator 25 is shown in FIGS. 5 to 7 and a second exemplary embodiment is shown for same in FIG. 8.

In the exemplary embodiment according to FIG. 5, the pressure washer 1, in particular the pump unit 18, has a bypass line 12. The pressure chamber 10 is fluidically connected to the suction chamber 9 by the bypass line 12. By means of the bypass line 12, a further fluidic connection of suction chamber 9 and pressure chamber 10 is possible that is separate from the fluidic connection of the suction chamber 9 to the pressure chamber 10 via the high-pressure pump 3.

If the high-pressure pump 3 is in operation, a greater pressure prevails in the pressure chamber 10 than in the suction chamber 9. Due to this pressure gradient, liquid can flow through the bypass line 12 from the pressure chamber 10 into the suction chamber 9. A bypass valve 13 is arranged in the bypass line 12. An open cross-sectional area of the bypass line 12 can be set by means of the bypass valve 13. As a result, the pressure in the pressure chamber 10 can be regulated. In the case of a larger open cross-sectional area, the pressure equalization between the pressure chamber 10 and the suction chamber 9 takes place to a greater extent. If a high pressure is intended to prevail in the pressure chamber 10, the open cross-sectional area of the bypass line 12 is reduced by means of the bypass valve 13. The larger the open cross-sectional area of the bypass line 12, in particular of the bypass valve 13, the greater the volume flow rate through the bypass line 13, in particular through the bypass valve 13, during operation, with otherwise unchanged conditions.

The bypass valve 13 can be adjusted between a fully closed state and a fully open state in stages or continuously. The bypass valve 13 can have different degrees of closing between the fully closed state and the fully open state. In the exemplary embodiments, the bypass valve 13 can be adjusted continuously at least in some sections. It can also be provided that the bypass valve can be adjusted between the fully closed state and the fully open state without interruption. The bypass valve 13 can be adjusted by means of a servomotor 16. The servomotor 16 is arranged in the pump unit 18. The bypass valve 13 can be adjusted by means of the servomotor 16 in such a way that the open cross-sectional area of the bypass line 12 can be set.

In the exemplary embodiment according to FIGS. 5 to 7, the pressure regulator 25 comprises the bypass line 12, the bypass valve 13 and the servomotor 16.

The operating device 7, in particular the pressure control element 42, generates a control signal that is dependent on an actuation, in particular on a degree of actuation, of the operating device 7, in particular of the pressure control element 42. The pressure regulator 25 regulates the pressure in the main line 5, in particular in the pressure chamber 10, on the basis of the control signal.

The pressure washer 1 is designed such that the bypass valve 13 sets the size of the open cross-sectional area depending on the adjustment position of the pressure control element 42. Depending on the adjustment position of the pressure control element 42, the pressure control element 42 generates a control signal. Different control signals can be generated by means of the pressure control element 42. In particular, control signals of differing intensity can be generated by means of the pressure control element 42. In particular, the intensity of a control signal increases as a function of the degree of actuation of the control element 42. On the basis of the control signal, in particular the intensity of the control signal, the pressure regulator 25 regulates the pressure in the main line 5, in particular in the pressure chamber 10. In particular, the size of the open cross-sectional area can be adjusted by means of the pressure control element 42 in at least six, in particular in at least ten stages. It can also be provided that the size of the open cross-sectional area can be adjusted continuously by means of the pressure control element. In the exemplary embodiment, the size of the open cross-sectional area can be adjusted by means of the pressure control element 42 in particular in at most 30, in particular in at most 20 stages. In the exemplary embodiment, the size of the open cross-sectional area can be adjusted quasi-continuously by means of the pressure control element 42. Quasi-continuously is presently understood to mean that the different pressure stages are so close together that if the user actuates the pressure control element 42, it appears to them as if the pressure were being continuously adjusted.

Depending on the degree of closing of the bypass valve 13, the magnitude of the volume flow rate of the liquid in the main line 5, in particular in the pressure chamber 10, can be set. The more the bypass valve 13 is closed, the smaller the open cross-sectional area of the bypass line 12. The more the bypass valve 13 is closed, the greater the volume flow rate of the liquid in the main line 5, in particular in the section between high-pressure pump 3 and spray opening 6. The more the bypass valve 13 is closed, the greater the volume flow rate of the liquid in the main line 5, present at the spray opening 6.

The bypass valve 13 can be adjusted by means of the operating device 7, in particular by means of the pressure control element 42. In the exemplary embodiments, the pressure control element 42 is used to set the open cross-sectional area of the bypass line 12. By adjusting the bypass valve 13, the pressure in the main line 5, in particular in the pressure chamber 10, in particular at the spray opening 6, can be regulated.

In the exemplary embodiment according to FIG. 8, the pressure in the main line 5, in particular in the pressure chamber 10, is changed, in particular regulated, by means of an alternative pressure regulator 25. In contrast to the exemplary embodiment according to FIGS. 5 to 7, no bypass line is provided in the exemplary embodiment according to FIG. 8. In order to adapt, in particular regulate, the pressure in the main line 5, in particular in the pressure chamber 10, in the exemplary embodiment according to FIG. 8 the motor speed of the motor 4 to drive the high-pressure pump 3 can be varied. In this case, the pressure control element 42 is used to specify, in particular to set, a motor speed of the motor 4. In the exemplary embodiment according to FIG. 8, the pressure regulator 25 comprises the motor 4 and the high-pressure pump 3. For this exemplary embodiment as well, the operating device 7, in particular the pressure control element 42, generates a control signal that is dependent on an actuation, in particular on a degree of actuation, of the operating device 7, in particular of the pressure control element 42, and the pressure regulator 25 regulates the pressure in the main line 5, in particular in the pressure chamber 10, on the basis of the control signal. In the exemplary embodiment according to FIG. 8, the speed of the motor 4 is changed, in particular set, in at least indirect dependence on the control signal, in particular an intensity of the control signal.

The pressure washer 1 is designed such that the motor speed of the motor 4 is set depending on the adjustment position of the pressure control element 42. The greater the motor speed of the motor 4, the greater the volume flow rate, in particular the pressure, of the liquid in the main line 5, in particular in the pressure chamber 10.

By means of the operating device 7, not only can the main line valve 8 be switched between the fully open state 20 and the closed state 40, but also the pressure in the main line 5 in the section between the high-pressure pump 3 and the spray opening 6 can be specified, in particular set.

The spray unit 11 is movable in relation to the pump unit 18. Between the pump unit 18 and the spray unit 11, the main line 5 is designed in the exemplary embodiments as a flexible hose. The spray opening 6 is arranged on the spray unit 11. The spray opening 6 of the spray unit 11 can be directed toward an object to be cleaned. The spray unit 11 is handheld. The operating device 7 is arranged on the spray unit 11. A user can hold the spray unit 11 with one hand and simultaneously operate the operating device 7 with the same hand.

The operating device 7 is preloaded in a non-actuated state. Both the valve control element 41 and the pressure control element 42 are preloaded independently of one another in a non-actuated state. To this end, in each case a spring not shown in the figures can be used.

In the exemplary embodiments, the operating device 7 is designed such that the pressure control element 42 can only be actuated if the valve control element 41 is actuated. However, it can also be provided that the pressure control element 42 can be actuated if the valve control element 41 is non-actuated.

The pressure washer 1 is designed such that the main line valve 8 is transferred from the fully closed state 20 into the fully open state 40 on actuation of the valve control element 41.

The pressure control element 42 can be adjusted within an adjustment range 31 shown in FIG. 5 or FIG. 8. Within the adjustment range 31, the pressure control element 42 can assume different adjustment positions, in particular depending on the degree of actuation of the pressure control element 42. It can be provided that the pressure control element 42 can be adjusted exclusively in stages. In the exemplary embodiments, the pressure control element 42 can be adjusted continuously within the adjustment range 31 to different adjustment positions.

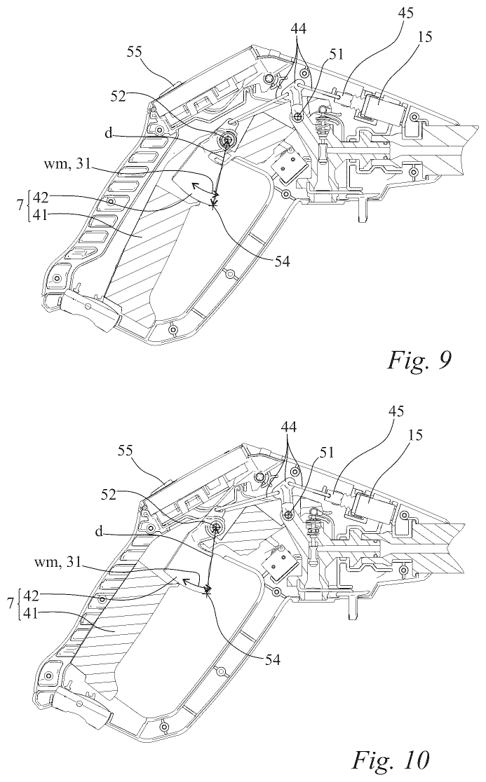

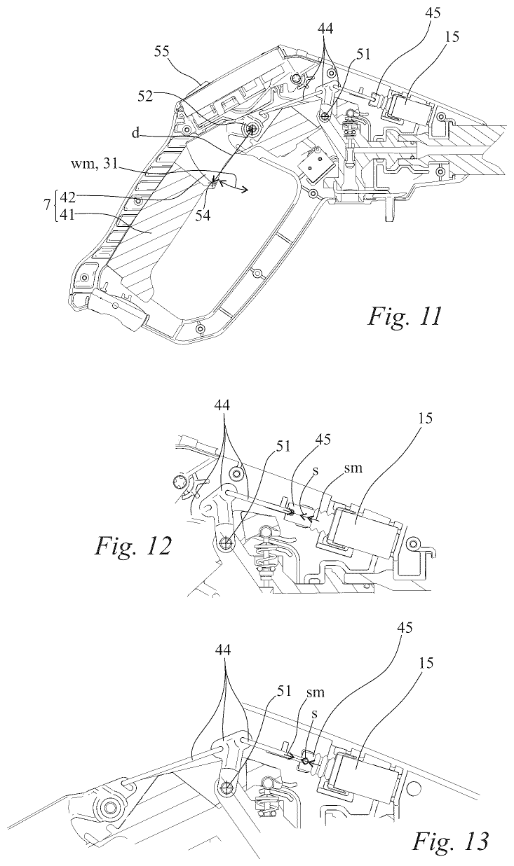

The pressure washer 1 comprises a detector 15. The detector 15 is shown schematically in FIGS. 5 to 8. The detector 15 is shown in more detail in the sectional views of the technical drawings according to FIGS. 9 to 11. The detector 15 is designed to detect an adjustment position, in particular a degree of actuation, of the operating device 7, in particular of the pressure control element 42 of the operating device 7. The detector 15 can detect any continuous adjustment position of the operating device 7, in particular of the pressure control element 42, within the adjustment range 31. It can be provided that the detector 15 is a Hall sensor. In the exemplary embodiment, the detector 15 is a potentiometer. The operating device 7, in particular the pressure control element 42, and the detector 15 are arranged on the spray unit 11 in such a way that detection of the adjustment position of the operating device 7, in particular of the pressure control element 42, is possible. The pressure control element 42 interacts with the detector 15 at least indirectly. In the exemplary embodiments, a mechanical connecting element 44 is arranged between the detector 15 and the operating device 7, in particular the pressure control element 42, as shown in FIGS. 9 to 11. The mechanical connecting element 44 couples the operating device 7, in particular the pressure control element 42, and the detector 15 to each other. By means of the mechanical connecting element 44, the operating device 7, in particular the pressure control element 42, interacts with the detector 15.

The detector 15 has a position element 45. The position element 45 can be adjusted along a maximum detector path sm. The maximum detector path sm and the position element 45 are in shown enlarged FIGS. 12 and 13. The detector 15 determines the value of the pressures specified by the pressure control element 42 in the main line 5 on the basis of a detector path s covered by a position element 45 of the detector 15 along the maximum detector path sm. In the exemplary embodiments, the position element 45 is a slider of the detector 15, which is designed as a potentiometer. However, it can also be provided that the position element is a magnet of the detector, which is designed as a Hall sensor. FIG. 12 shows the position element 45 in a non-actuated pressure control element 42. FIG. 13 shows the position element 45 with pressure control element 42 actuated at its maximum. Due to the actuation of the pressure control element 42, the position element 45 is adjusted by the detector path s along the maximum detector path sm. This causes the position element 45 to move in relation to a measuring unit of the detector 15, in the exemplary embodiment a coil. The change in position of the position element 45 is detected by the measuring unit of the detector 15. In this case, in the exemplary embodiments, the control signal is generated. The control signal corresponds to the signal that is generated when the position of the pressure control element 42, in particular the position of the position element 45, is detected in the detector 15. The control signal is generated indirectly by the operating device 7, in particular the pressure control element 42. In particular, the control signal is generated indirectly as a function of the actuation, in particular the degree of actuation, of the operating device 7, in particular of the pressure control element 42. The control signal can be another signal, however, which is generated on the signal path between the operating device 7 and the pressure regulator 25.

The mechanical connecting element 44 mechanically connects the position element 45 and the pressure control element 42 to each other.

As shown in particular in FIGS. 5 to 8, the pressure control element 42 can be adjusted along a travel path in an adjustment range 31 from a rest position 37 to adjustment positions with increasing distance from the rest position 37. The pressure control element 42 assumes the maximum distance from the rest position 37 in an end position 38. In the end position 38, the pressure control element has covered the maximum travel path wm. The pressure washer 1 is designed such that as the distance of the pressure control element 42 from the rest position 37 increases, control signals with a larger or with a smaller intensity are generated. In the exemplary embodiment, the intensity of the control signals increases as the distance of the pressure control element 42 from the rest position 37 increases. As the intensity of the control signals increases, the pressure regulator 25 regulates a greater or at least no lower pressure in the main line 5, in particular in the pressure chamber 10, in a standard mode of the pressure washer 1. If the pressure control element 42 is in the end position 38, it generates, in particular the detector 15, a control signal of maximum intensity. In the standard mode of the pressure washer 1, a maximum possible pressure in the main line 5, in particular in the pressure chamber 10, is then regulated by means of the pressure regulator 25. The pressure control element 42 is preloaded in particular into the rest position 37.

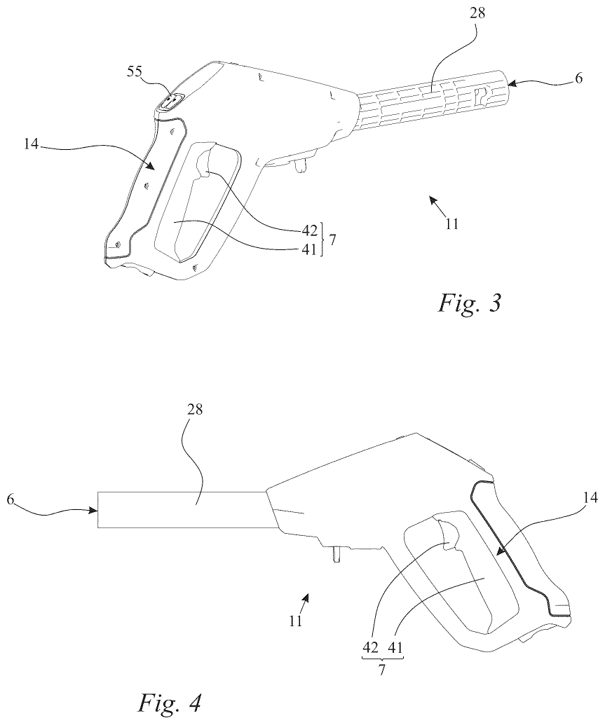

The distance from the rest position 37 relates to the distance of a reference point on the pressure control element 42. In the exemplary embodiments, the pressure control element 42 is a pivot lever that can pivot about a pressure control element pivot axis 52. In the exemplary embodiment, the reference point is the point on the pressure control element 42 with the greatest distance from the pressure control element pivot axis 52. This point is referred to as pressure point 54 and is shown in FIGS. 9 to 11. The corresponding distance of the pressure point 54 from the pressure control element pivot axis 52 is referred to as maximum pressure distance d. The pressure point 54 is arranged, in relation to the pressure control element pivot axis 52, on that side of the pressure control element 42 which is actuated by the operator. The pressure point 54 is the point on the pressure control element 42 that, in relation to the position of the pressure control element pivot axis 52, is arranged on that side of the pressure control element 42 which is averted from a handle area 14 (FIG. 3 or 4), against which the hand, in particular the metacarpus, in particular the palm, of a user rests during operation of the pressure washer 1, and which has the maximum pressure distance d (FIGS. 8 to 11) from the pressure control element pivot axis 52. In the exemplary embodiments, the rest position 37 is defined by the position of the reference point when pressure control element 42 is non-actuated.

On actuation of the pressure control element 42, designed as pivot lever, in the rest position 37 of the pressure control element 42, the pressure control element 42—and therefore also the reference point—is pivoted within the adjustment range 31 along the travel path. In this case, the travel path is a segment of a circle. The distance of the pressure control element 42 from the rest position 37 corresponds to the distance of the reference point from the rest position 37 as measured along the travel path designed as a segment of a circle. For reasons of better illustration, the travel path in FIGS. 9 to 11 is arranged radially slightly offset from the pressure point 54. In actual fact, the circular arc segment line starts from the position of the pressure point 54 in FIG. 9. The pressure point 54 moves in relation to the pivot movement about the pressure control element pivot axis 52 on a circular path. Provision can also be made to measure the distance in the form of an angular distance of the reference point from the rest position in relation to a pivoting movement about the pressure control element pivot axis 52.

The pressure control element 42 can be adjusted along the maximum travel path wm (FIGS. 5 to 11). The maximum travel path wm of the pressure control element 42 is at least 110%, in particular at least 150%, in particular at least 200% of the maximum detector path sm of the position element 45. The movement of the pressure control element 42 along its travel path is converted into a movement of the position element 45 along the travel path of the latter. In the process, a pivoting movement of the pressure control element 42 is converted into a linear movement of the position element 45. For this purpose, the mechanical connecting element 45 comprises multiple joints.

In all exemplary embodiments, the pressure washer 1 is designed such that the pressure regulator 25 regulates as a function of the adjustment position of the pressure control element 42. To this end, the detector 15 detects the adjustment position of the pressure control element 42 and generates a signal, in particular the control signal, on the basis of which the pressure regulator 25 regulates the pressure in the main line 5, in particular in the pressure chamber 10. In the exemplary embodiments, in all operating modes of the pressure washer 1, there is a fixed, invariable link between the adjustment position of the operating device 7, in particular of the pressure control element 42, and the generated control signal, in particular the intensity of the generated control signal. The assignment of adjustment position and control signal, in particular intensity of the control signal, is always the same, irrespective of the selected operating mode.

In the exemplary embodiments, the valve control element 41 is a pivot lever pivotable about a valve control element pivot axis 51 shown in FIGS. 9 to 11. In particular, the valve control element 41 is mounted in the spray unit 11, in particular in a housing of the spray unit 11, so as to pivot about the valve control element pivot axis 51. In particular, the pressure control element 42 is a pivot lever that can pivot about a pressure control element pivot axis 52 shown in FIGS. 9 to 11.

The pressure washer 1 has a control unit 22 shown in FIGS. 5 to 7. The control unit 22 is arranged in the pump unit 18. It can also be provided that the control unit 22 is arranged in the spray unit 11. The signal generated by the detector 15, in particular the control signal, is transmitted directly or indirectly, in particular in the form of a wireless, in particular electromagnetic, signal to the control unit 22.

It can be provided that the control signal is converted into other signals after it has been generated and before it is received by the control unit 22. However, this conversion takes place in such a way that the other signals are determined on the basis of the control signal. In particular, the intensity of the other signals is determined on the basis of the intensity of the control signal. In particular, the other signal, in particular the intensity of the other signal, is proportional to the intensity of the control signal. Although the control signal can be amplified or converted into another signal en route to the control unit 22, the control signal is always used as a basis for assessing another signal. In particular, the other signals are exclusively electrical and/or electromagnetic signals. In particular, a possible signal chain between the control signal and the control unit 22 comprises exclusively electrical and/or electromagnetic signals, in particular no mechanical and/or hydraulic signal transmission.

The signal received by the control unit 22 is used to change, in particular regulate, the pressure in the section of the main line 5 between the high-pressure pump 3 and the spray opening 6, in particular by means of the pressure regulator 25. In particular, on the basis of the signal received by the control unit 22, a pressure signal is generated by the control unit 22. The pressure signal is transmitted from the control unit 22 to the pressure regulator 25. The pressure signal is transmitted in particular directly or indirectly, in particular in the form of a wireless, in particular electromagnetic, signal, from the control unit 22 to the pressure regulator 25. However, it can also be provided that the pressure signal is transmitted by a cable, in particular as an electrical signal. The pressure regulator 25 regulates the pressure in the main line 5, in particular in the pressure chamber 10, in accordance with the pressure signal.

The pressure washer 1 can be operated in standard mode. The standard mode is an operating mode of the pressure washer 1. In the standard mode, the pressure in the main line 5, in particular in the pressure chamber 10, can be regulated within a standard pressure range by means of the pressure regulator 25. In the exemplary embodiments, the standard pressure range is the greatest possible pressure range that can be regulated with the pressure regulator 25. The standard pressure range has a standard minimum value and a standard maximum value for the pressure. In the exemplary embodiments, the standard minimum value is zero. The standard maximum value is the largest pressure value that can be regulated with the pressure regulator 25 in the main line 5, in particular in the pressure chamber 10, in particular under the boundary conditions determined by the other components of the pressure washer 1. However, it can also be provided that the standard pressure range does not fully use the entire possible pressure value spectrum. Typically, however, the standard pressure range is the largest pressure range in which the pressure in an operating mode of the pressure washer 1 in the main line 5, in particular in the pressure chamber 10, can be regulated.

The pressure washer 1 has in all exemplary embodiments a special mode. The special mode is an operating mode of the pressure washer 1. The pressure washer 1 can be operated in standard mode or in special mode. In the special mode, the pressure can be regulated within a special pressure range in the main line 5, in particular in the pressure chamber 10, by means of the pressure regulator 25. The special pressure range is restricted compared to the standard pressure range. The special pressure range has a special minimum value and a special maximum value for the pressure. The special minimum value and the special maximum value delimit the special pressure range. The special minimum value is also referred to as lower special limit pressure value. The special maximum value is also referred to as upper special limit pressure value. The special minimum value is greater than the standard minimum value and/or the special maximum value is less than the standard maximum value. It can also be provided that the special minimum value and the special maximum value are the same value. Even such an individual value is referred to as a special pressure range.

In the exemplary embodiments, there is a different assignment of control signals received by the control unit 22 and pressure signals emitted by the control unit in special mode compared to in standard mode. It is possible that, due to the same incoming control signal, a different pressure signal is generated by the control unit 22 in special mode than in standard mode. Subsequently, a different pressure is then regulated in the main line 5, in particular in the pressure chamber 10, by the pressure regulator 25.

The pressure washer 1 can be adjusted to the special operating mode by means of an operating mode signal during actuation of the operating device 7, in particular the pressure control element 42, in standard mode. In the exemplary embodiments, the operating mode signal is triggered by the user. A button 55, shown in FIG. 2, in FIG. 5 or in FIG. 8, is provided for this purpose. The button 55 is used to generate the operating mode signal. The operating mode signal can be generated by actuating the button 55, particularly if the pressure washer 1 is in standard mode. The button 55 is arranged on the spray unit 11. In particular, the button 55 can be actuated with the thumb during actuation of the operating device 7, in particular the pressure control element 42, with at least one three-joint finger. In particular, the operating mode of the pressure washer 1 can be adjusted to standard mode by actuating the button 55 in special mode.

In the exemplary embodiments, the operating mode signal is transmitted to the control unit 22. This can be done by means of an electrical signal, in particular using a cable. In the exemplary embodiments, the operating mode signal is transmitted wirelessly, in particular electromagnetically, to the control unit 22. The control unit 22 adjusts the pressure washer 1 from standard mode to special mode on receipt of the operating mode signal.

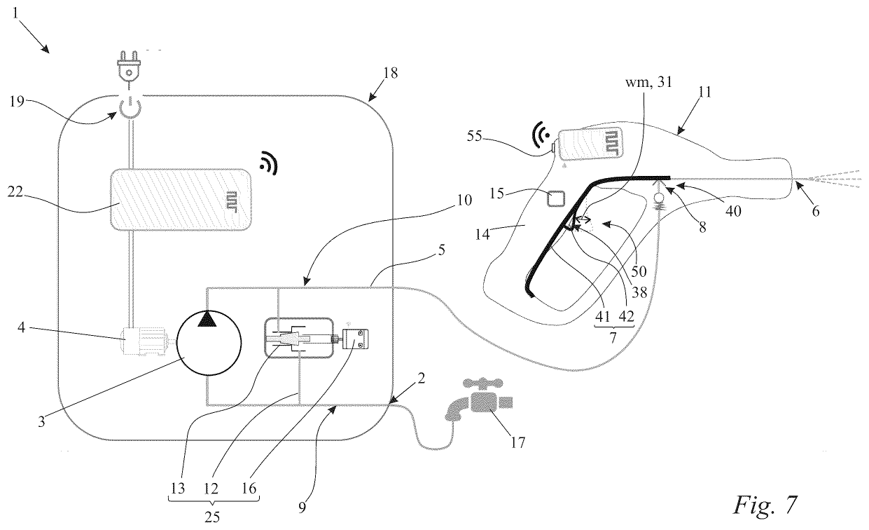

In the special mode, a set value is ascertained from the control signal, which is generated by the operating device 7, in particular by the pressure control element 42. It can also be provided that the set value is ascertained from multiple control signals. In both cases, it is a control signal or multiple control signals, which were generated prior to or during the switch to the special mode. In the exemplary embodiments, the control unit 22 receives the control signal or the control signals and ascertains the set value therefrom. In particular, the set value corresponds to an intensity of a control signal which is, in particular was, generated by the operating device 7, in particular the pressure control element 42. In particular, the control signal, on the basis of which the set value is determined, is a control signal which is generated by the operating device 7, in particular by the pressure control element 42 in an adjustment position between the rest position 37 (FIG. 6) and the end position (FIG. 7). It can also be provided that on the basis of the control signal, as described above, another signal is generated, on the basis of which the set value is then ascertained.

The ascertained set value is saved at least temporarily. In the exemplary embodiments, this is done by the control unit 22.

In the special mode, the special pressure range is determined using the set value. An upper special limit pressure value is an upper limit of the special pressure range. The upper special limit pressure value is also referred to as special maximum value. A lower special limit pressure value is a lower limit of the special pressure range. The lower special limit pressure value is also referred to as special minimum value. In particular, the special minimum value and/or the special maximum value is determined using the set value. This is done in the exemplary embodiments by the control unit 22.

The special mode can be a first special operating mode, a second special operating mode and/or a third special operating mode. In the exemplary embodiments, the pressure washer 1 can be operated in the first special operating mode, in the second special operating mode or the third special operating mode.

The operating mode signal can be a first mode signal, a second mode signal and/or a third mode signal. The first mode signal is used to adjust the operating mode of the pressure washer 1 to the first special operating mode. The second mode signal is used to adjust the operating mode of the pressure washer 1 to the second special operating mode. The third mode signal is used to adjust the operating mode of the pressure washer 1 to the third special operating mode.

In particular, every mode signal can be generated in a different way by the operator. In particular, the individual mode signals are generated by actuating button 55. On actuating the button for the first time, the first mode signal is generated. When the button 55 is actuated in the first special operating mode, the second mode signal is generated. When the button 55 is actuated in the second special operating mode, the third mode signal is generated. In the exemplary embodiments, each of the three special operating modes is assigned its own button for generating the assigned mode signal.

In the first special operating mode, the special pressure range is an individual pressure value. In the exemplary embodiments, this individual pressure value corresponds to the pressure value that the pressure regulator 25 would specify for the pressure in the main line 5, in particular in the pressure chamber 10, in standard mode if the operating device 7, in particular the pressure control element 42, were to generate the set value as a control signal. In the exemplary embodiments, in the first special operating mode, the pressure regulator 25 regulates the pressure in the main line 5, in particular in the pressure chamber 10, to the individual value, irrespective of the control signal generated by the operating device 7, in particular the pressure control element 42, in the first special operating mode. In the first special operating mode, the pressure in the main line 5, in particular in the pressure chamber 10, is regulated by the pressure regulator 25 exclusively on the basis of the set value. Control signals, received in the first special operating mode by the control unit 22, are not used for generating pressure signals. The pressure signal sent from the control unit 22 to the pressure regulator is generated exclusively on the basis of the set value. This is done irrespective of the degree of actuation of the operating device 7, in particular of the pressure control element 42.

In particular, it can be provided that, in the first special operating mode, the operating device 7, in particular the pressure control element 42, can be fixed in a fixed adjustment position, in particular with a fixed degree of actuation. In particular, in the first special operating mode, it is not possible to change the adjustment position, in particular the degree of actuation, of the operating device 7, in particular of the pressure control element 42. In the exemplary embodiments, this is not the case. In the first special operating mode, it is possible to adjust the operating device 7, in particular the pressure control element 42, to the same adjustment positions as in standard mode. However, the different control signals generated in the different adjustment positions are not used for generating different pressure signals.

In particular, the control signal generated at the time of switching to the first special operating mode is multiplied by a factor and saved at least temporarily as set value. If the multiplication results in a set value the intensity of which is greater than the maximum intensity that can be generated in standard mode, the set value is determined in accordance with this maximum intensity.

In the exemplary embodiments, the factor is 1. In other words, the set value corresponds to the control signal generated at the time of switching to the first special operating mode. This is true in particular of the intensity of this control signal.

In the second special operating mode, at least one extreme value of the special pressure range is determined on the basis of the set value. In particular, the special pressure range within which the pressure in the main line 5, in particular in the pressure chamber 10, can be regulated by means of the pressure regulator 25, is delimited by a pressure value ascertained on the basis of the set value. In the exemplary embodiments, in the second special operating mode, the pressure value assigned to the set value in standard mode is determined as the special maximum value or the special minimum value of the special pressure range.

If the special maximum value corresponds to the set value, the control unit 22 only outputs pressure signals that are not greater than the pressure signal that would be generated in standard mode on reception of a control signal corresponding to the set value. If the control unit 22 receives control signals that are greater than the set value, the control unit 22 nevertheless only generates the pressure signal corresponding to the set value as control signal in standard mode. As a result, the pressure value specified by the pressure regulator 25 in the main line 5, in particular in the pressure chamber 10, is limited to the special maximum value.

If the special minimum value corresponds to the set value, the control unit 22 only outputs pressure signals that are not smaller than the pressure signal that would be generated in standard mode on reception of a control signal corresponding to the set value. If the control unit 22 receives control signals that are smaller than the set value, the control unit 22 nevertheless only generates the pressure signal corresponding to the set value as control signal in standard mode. As a result, the pressure value specified by the pressure regulator 25 in the main line 5, in particular in the pressure chamber 10, is limited to values that correspond at least to the special minimum value.

The pressure signal spectrum can be restricted independently of the degree of actuation, in particular the adjustment position, of the operating device 7, in particular of the pressure control element 42. It can be provided that, in the second special operating mode, the degree of actuation of the operating device 7, in particular of the pressure control element 42, is limited by that adjustment position of the operating device 7, in particular of the pressure control element 42, which the operating device 7, in particular the pressure control element 42, assumes in standard mode when a control signal corresponding to the set value is generated. In particular, it can be provided that the operating device 7, in particular the pressure control element 42, can be actuated in the second special operating mode exclusively between the rest position 37 and an adjustment position that corresponds to the adjustment position at which a control signal corresponding to the set value is generated in standard mode.

Alternatively, it can be provided that the operating device 7, in particular the pressure control element 42, can be actuated in the second special operating mode exclusively between the adjustment position, at which a control signal corresponding to the set value is generated in standard mode, and the end position 38.

This limiting of the travel path of the operating device 7, in particular of the pressure control element 42, can be effected mechanically, in particular triggered by the control unit 22.

In the exemplary embodiments, unrestricted actuation of the operating device 7, in particular of the pressure control element 42, is also possible in the second special operating mode. As described, control signals, which would be used in standard mode to generate pressure signals above the special maximum value or below the special minimum value, are used to generate a pressure signal that regulates the special maximum value or the special minimum value, respectively, by means of the pressure regulator 25. In the control unit 22, the incoming control signals are assigned for a part of the control signal spectrum to other pressure values or to a pressure value assigned to the set value in standard mode.

It can also be provided that, in the second special operating mode, both the special maximum value and the special minimum value of the special pressure range are determined on the basis of the set value. The special minimum value can, for example, correspond to a certain lower percentage value of the pressure value that was assigned to the set value in standard mode. The special maximum value of the special pressure range can, for example, correspond to a certain upper percentage value of the pressure correspond that was assigned to the set value in standard mode. The upper percentage value is greater than the lower percentage value. In particular, the upper percentage value is more than 100% and the lower percentage value is less than 100%. In particular, the mean of lower percentage value and upper percentage value is from 90% to 110%, in particular 100%. The control signals are then assigned in the control unit 22 as already described, except that the sent pressure signals are limited both at the upper end of the pressure signal spectrum and at the lower end. In a middle range of the control signal spectrum, the assignment between control signal and pressure signal remains unchanged compared to the standard mode. In the upper range, the only pressure signal generated is the one which, in standard mode, is assigned to the control signal that corresponds to the set value multiplied by the upper percentage value. In the lower range, the only pressure signal generated is the one which, in standard mode, is assigned to the control signal that corresponds to the set value multiplied by the lower percentage value. In particular, it is possible to adjust the operating device 7, in particular the pressure control element 42, along the travel path over the entire adjustment range 31. The special pressure range is limited exclusively by a new assignment of control signals and pressure signals in the control unit 2.

In the third special operating mode, the operating device 7, in particular the pressure control element 42, can be adjusted, just as in standard mode, along the travel path between the rest position 37 (FIG. 6) and the end position 38 (FIG. 7). This also applies to the exemplary embodiment according to FIG. 8. In the third special operating mode, the rest position 37 is linked to the special minimum value and the end position 38 is linked to the special maximum value. The control signals generated by the operating device 7, in particular the pressure control element 42, are linked in the control unit 22 in the third special operating mode to other pressure signals sent by the control unit 22 to the pressure regulator 25. The pressure signal spectrum is restricted in the third special operating mode. In comparison with the second special operating mode, in the third special operating mode, it is possible to generate a greater number of pressure signals. The intervals between different, directly adjacent pressure signals, or between the intensities thereof, are smaller than in standard mode, in particular than in the second special operating mode. In particular, in the third special operating mode, another pressure signal is assigned to each control signal. This is not the case in the second special operating mode in the exemplary embodiments. In the third special operating mode, in particular the entire available spectrum of control signals is spread across a restricted spectrum of pressure signals, in particular more finely than in standard mode. This means that it is possible to select a certain pressure value by means of the operating device 7, in particular by means of the pressure control element 42, within a restricted special pressure range, but with greater accuracy, with smaller intervals between the pressure values. In particular, the pressure values of the special pressure range are spread uniformly over the entire adjustment range 31 of the operating device 7, in particular of the pressure control element 42.

In the third special operating mode too, it can be provided that, as in the second special operating mode, at least one extreme value of the special pressure range is determined on the basis of the set value. In particular, the special pressure range, within which the pressure in the main line 5, in particular in the pressure chamber 10, can be regulated by means of the pressure regulator 25, is limited by a pressure value ascertained on the basis of the set value. In the exemplary embodiments, in the third special operating mode, the pressure value assigned to the set value in standard mode is determined as the special maximum value or the special minimum value of the special pressure range. In this configuration of the third special operating mode, the upper or lower end of the special pressure range is delimited by the pressure value assigned to the set value in standard mode and, simultaneously, the special pressure range is spread across the maximum possible adjustment range 31 of the operating device 7, in particular of the control element 42.

The further, above-described configurations of the second special operating mode can also be combined with the third special operating mode, wherein, in the third special operating mode, the maximum possible adjustment range 31 is always utilized. In particular, in the third special operating mode as well, both the special maximum value and the special minimum value of the special pressure range can be determined on the basis of the set value. The special minimum value can, for example, correspond to a certain lower percentage value of the pressure value that was assigned to the set value in standard mode. The special maximum value of the special pressure range can, for example, correspond to a certain upper percentage value of the pressure that was assigned to the set value in standard mode. The further possible configurations in this regard are described hereinabove in connection with the second special operating mode.

The use of the pressure washer 1, in particular of the operating device 7, in standard mode is shown in FIGS. 5 to 7 by way of example also for the exemplary embodiment according to FIG. 8, chronologically beginning with the closed state 20 of the main line valve 8 in the non-actuated state 30 of the operating device 7, in particular in the non-actuated state of the pressure control element 42 (FIG. 5), and ending with the fully open state 40 of the main line valve 8 and maximum pressure specified by the pressure regulator 25 in the main line 5, in particular in the pressure chamber 10, in the fully actuated state 50 (FIG. 7) of the operating device 7, in which both the valve control element 41 and the pressure control element 42 are actuated fully, in particular at their maximum. In the exemplary embodiment according to FIGS. 5 to 7, the pressure regulator 25 enables maximum pressure in standard mode by fully closing the bypass valve 13 (FIG. 7). In the exemplary embodiment according to FIG. 8, the pressure regulator 25 enables maximum pressure in standard mode as a result of the motor 4 driving the high-pressure pump 3 at maximum power.

In FIG. 5, the operating device 7 is in the non-actuated state 30. The intensity of the control signal is minimal or even zero. This applies to all operating modes. Neither the valve control element 41 nor the pressure control element 42 are actuated. The main line valve 8 is closed. No liquid is sprayed from the spray opening 6. The bypass valve 13 is fully open in standard mode due to the minimal or non-existent intensity of the control signal. The pressure in the pressure chamber 10 is thereby minimized for the closed state 20 of the main line valve 8. In the exemplary embodiment according to FIG. 8, the motor 4 is not driven in the same state of the operating device 7 in standard mode due to the minimal or non-existent intensity of the control signal. The motor 4 is at a standstill.

Proceeding from the non-actuated state 30 of the operating device 7 shown in FIG. 5, firstly the valve control element 41 of the operating device 7 is actuated. As a result, the main line valve 8 is transferred from the closed state 20 to the open state 40.

This half-actuated state 60 of the operating device 7, in which only the valve control element 41 and not the pressure control element 42 is actuated, is shown in FIG. 6. Liquid is sprayed from the spray opening 6. The pressure control element 42 is non-actuated. The intensity of the control signal is minimal or non-existent. The bypass valve 13 is fully open in standard mode due to the minimum or non-existent intensity of the control signal. In the exemplary embodiment according to FIG. 8, the motor 4 is not driven in standard mode due to the minimum or non-existent intensity of the control signal. The motor 4 is at a standstill. The pressure in the section of the main line 5 between the high-pressure pump 3 and the spray opening 6, or in the pressure chamber 10, is minimal in standard mode for the fully open state 40 of the main line valve 8 in both exemplary embodiments.

During the transition from the half-actuated state 60 of the operating device 7 shown in FIG. 6 to the fully actuated state 50 of the operating device 7 shown in FIG. 7, the valve control element 41 continues to be actuated. The main line valve 8 continues to be in the fully open state 40. The pressure control element 42 is lightly actuated, in particular in an adjustment position between the non-actuated and the fully actuated state of the pressure control element 42. The pressure control element 42 assumes an adjustment position between the rest position 37 (FIG. 6) and an end position 38 (FIG. 7) of the pressure control element 42. Due to this adjustment position of the pressure control element 42, a control signal having an intensity between the maximum and the minimum intensity is generated. This applies in the exemplary embodiments to all operating modes. This control signal is received by the control unit 22. The control unit 22 then sends the pressure regulator 25 a pressure signal, which was assigned in standard mode to the received control signal. The pressure regulator 25 then regulates the pressure in the main line 5, in particular in the suction chamber 10, to a value between the extreme values of the standard pressure range available in standard mode. In the exemplary embodiment according to FIG. 6, the bypass valve 13 is then neither fully open nor fully closed, but rather half open. The pressure in the section of the main line 5 between the high-pressure pump 3 and the spray opening 6, or in the pressure chamber 10, is greater than in FIG. 6, but less than in FIG. 7. In the exemplary embodiment according to FIG. 8, when the pressure control element 42 is lightly actuated, the motor 4 is operated in standard mode with an output between the maximum output and zero due to the intensity of the control signal between the minimum and the maximum intensity. If, in this state with fully open main line valve 8 and an adjustment position of the pressure control element 42 between the rest position 37 and the end position 38, the pressure washer 1 is adjusted to special mode, in which the operating mode signal is generated by actuating the control surface 55, the control unit 22 in the exemplary embodiments receives the same control signals as in standard mode, but under certain circumstances does not send the same pressure signal to the pressure regulator 25 as in standard mode. In one configuration, in every special mode, when the operating mode signal is generated, the control signal received at that moment from the control unit 22 is saved as a set value.

In the first special operating mode, the pressure control element 42 can then be adjusted to other adjustment positions and therefore other control signals also arrive at the control unit 22, but the control unit 22 only ever sends the same pressure signal to the pressure regulator 25. This pressure signal corresponds to the pressure signal that the control unit 22 sends in standard mode to the pressure regulator 25 if it receives a control signal that corresponds to the set value.

In one of the described configurations of the second special operating mode, on reception of control signals lying below the set value, the control unit 22 only ever sends the pressure regulator 25 the pressure signal that was assigned to the set value in standard mode. For the reception of the remaining control signals, the pressure washer 1 behaves the same as in standard mode.

In a described configuration of the third special operating mode, the pressure signal assigned to the set value in standard mode by the control unit 22 is now assigned by the control unit 22 to the smallest control signal that can be generated with the pressure control element 42. The largest control signal that can be generated continues to be assigned to the largest pressure signal that can be generated. Each value from the entire control signal spectrum is assigned a pressure signal at uniform intervals between the pressure signal that is assigned to the set value in standard mode and the maximum pressure signal that can be generated in standard mode.

The standard mode is shown again in FIG. 7. The pressure control element 42 is adjusted to the end position 38. A control signal of maximum intensity is generated. In the standard mode, the bypass valve 13 is fully closed due to the control signal of maximum intensity. No more liquid can flow back through the bypass line 12 from the pressure chamber 10 into the suction chamber 9. In the exemplary embodiment according to FIG. 8, the motor 4 is operated at maximum output in standard mode due to the control signal of maximum intensity. The pressure in the pressure chamber 10 is at its maximum for the open state 40 of the main line valve 8 in both exemplary embodiments. The valve control element 41 continues to be fully actuated. The main line valve 8 continues to be in the fully open state 40. The operating device 7 is in the fully actuated state 50. In standard mode, liquid is sprayed from the spray opening 6 at maximum pressure.

If, as described, a switch had previously been made to special mode, sometimes liquid is not sprayed at maximum pressure, even though the pressure control element 42 is fully actuated. In the first special operating mode, the pressure regulator 25 then specifies a fixed pressure value, irrespective of the adjustment position of the pressure control element 42. In the variants of the second and third special operating mode described hereinabove in conjunction with the transition from FIG. 6 to FIG. 7, the pressure regulator 25 would receive the largest possible pressure signal from the control unit 22 and accordingly liquid would be sprayed at maximum pressure.

In all exemplary embodiments, the pressure washer 1 is designed such that when the pressure washer 1 is switched on, in particular by means of the main switch 19, it is always first set in standard mode. If the pressure washer 1 was in special mode when it was switched off, in particular by means of the main switch 19, then it will be in standard mode when it is switched on, in particular by means of the main switch 19, in standard mode.

1.-20. (canceled)

21. A pressure washer, comprising:
a main line (5) configured to convey liquid from a high-pressure pump (3);
an operating device (7) configured to generate a control signal dependent on actuation of the operating device (7); and
a pressure regulator (25) configured to regulate a pressure in the main line (5) based on the control signal,
wherein, in a standard mode of the pressure washer (1), the pressure in the main line (5) can be regulated within a standard pressure range by the pressure regulator (25), and
wherein, during actuation of the operating device (7) in standard mode, the pressure washer (1) can be adjusted by an operating mode signal to a special mode,
wherein, in the special mode, a set value is ascertained from the control signal or from multiple control signals and the set value is saved at least temporarily,
wherein, in the special mode, the pressure in the main line (5) can be regulated within a special pressure range by the pressure regulator (25),
wherein the special pressure range is restricted compared to the standard pressure range, and
wherein the special pressure range is determined using the set value.

22. The pressure washer according to claim 21,
wherein, in the special mode, the control signal generated by the operating device (7) at the time of switching to the special mode is saved at least temporarily as the set value.

23. The pressure washer according to claim 21,
wherein the special mode is a first special operating mode, and
wherein the special pressure range in the first special operating mode is an individual pressure value.

24. The pressure washer according to claim 21,
wherein the special mode is a second special operating mode,
wherein, in the second special operating mode, at least one extreme value of the special pressure range is determined based on the set value.

25. The pressure washer according to claim 21,
wherein the special mode is a third special operating mode,
wherein the operating device (7) can be adjusted along a travel path between two extreme positions (37, 38),
wherein, in the standard mode, the extreme positions (37, 38) are linked to extreme values of the standard pressure range, and
wherein, in the third special operating mode, the extreme positions (37, 38) are linked to the extreme values of the special pressure range.

26. The pressure washer according to claim 25,
wherein, in the third special operating mode, at least one extreme value of the special pressure range is determined based on the set value.

27. The pressure washer according to claim 21,
further comprising a button (55),
wherein the operating mode signal can be generated by actuating the button (55).

28. The pressure washer according to claim 21,
wherein the operating mode signal can be
a first mode signal for adjusting the pressure washer (1) to a first special operating mode, or
a second mode signal for adjusting the pressure washer (1) to a second special operating mode, or
a third mode signal for adjusting the pressure washer (1) to a third special operating mode.

29. The pressure washer according to claim 21,
wherein when the pressure washer (1) is switched on, the pressure washer (1) is always first set in standard mode.

30. The pressure washer according to claim 21,
wherein the control signal generated by the operating device (7) is dependent on a degree of actuation of the operating device (7).

31. The pressure washer according to claim 23,
wherein the individual pressure value is the pressure value that corresponds to the set value in standard mode.

32. The pressure washer according to claim 23,
wherein, in the first special operating mode, the pressure regulator (25) regulates the pressure in the main line (5) to the individual pressure value independently of the control signal.

33. The pressure washer according to claim 24,
wherein, in the second special operating mode, the pressure value assigned to the set value in standard mode is determined as being the largest or the smallest pressure value in the special pressure range.

34. The pressure washer according to claim 25,
wherein a pressure control element (42) of the operating device (7) can be adjusted along the travel path between the two extreme positions (37, 38).

35. The pressure washer according to claim 26,
wherein, in the third special operating mode, the pressure value assigned to the set value in standard mode is determined as being the largest or the smallest pressure value in the special pressure range.

36. The pressure washer according to claim 27,
wherein the operating mode of the pressure washer (1) can be adjusted back to the standard mode by actuating the button (55) while in the special mode.

37. The pressure washer according to claim 28,
wherein every mode signal can be generated by the operator in a different way.

38. A method for operating a pressure washer, the pressure washer (1) comprising:
a main line (5) configured to convey liquid from a high-pressure pump (3);
an operating device (7) configured to generate a control signal dependent on actuation of the operating device (7); and
a pressure regulator (25) configured to regulate a pressure in the main line (5) based on the control signal,
the method comprising:
regulating, in a standard mode of the pressure washer (1), a pressure in the main line (5) within a standard pressure range by the pressure regulator (25);
adjusting the pressure washer (1), during the actuation of the operating device (7) in standard mode, by an operating mode signal to a special mode;
ascertaining, in the special mode, a set value from the control signal generated by the operating device (7) or from multiple control signals generated by the operating device (7);
saving the set value at least temporarily;
regulating, in the special mode, the pressure in the main line (5) within a special pressure range by the pressure regulator (25), wherein the special pressure range is restricted compared to the standard pressure range; and
using the set value to determine the special pressure range.

39. The method according to claim 38,
wherein the control signal generated by the operating device (7) depends on a degree of actuation of the operating device (7).

40. The method according to claim 38,
wherein the control signal is generated at the time of switching to the special mode.
